(19) United States
(12) Patent Application Publication
(10) Pub. No.: US 2012/0132300 A1
(43) Pub. Date: May 31, 2012

(54) FAIL-SAFE WATER DISTRIBUTION SYSTEM

(76) Inventor: Mohammed A. HANIF, Waterdown (CA)

(21) Appl. No.: 12/954,689

(22) Filed: Nov. 26, 2010

(51) Int. Cl. F17D 3/00

(52) U.S. Cl. 137/552.7

(57) ABSTRACT

A fail-safe fluid, particularly, water distribution apparatus for use within residential, commercial and industrial buildings comprising (i) a conduit through which fluid is distributed; (ii) a fluid flow time-sensitive sensor cooperative with the conduit to operably detect fluid flow within the conduit over desired periods of time; and (iii) a fluid control valve to control the flow of the fluid within the conduit cooperative with the sensor.

### FIELD OF THE INVENTION

This invention relates to fluid, particularly water distribution systems, particularly within residential, commercial and industrial buildings and more particularly to fail-safe apparatus within said systems.

### BACKGROUND OF THE INVENTION

A potential and often occurring problem within residential, commercial and industrial buildings is water leakage from conduits, pipes and the like.

At present, water shut-off valves are manually operated when necessary or when desired. It is known that necessary action is often taken in situations which are not beneficial to the owner or user of a property. For instance, it could take a person 3-4 minutes to reach the valve if a leak occurs at an upper level of the building. A significant number of home owners or renters do not know where the valve is actually located. A further significant number of these persons use the valve location as storage area. Yet further, significant numbers of valves are seized or will not shut off the water flow completely. These and related problems with external main controlled valves being the responsibility of the city constitute serious water leak problem situations.

Similarly, problems occur with other fluid systems such as gas and oil distribution systems.

There is, therefore, a need for a fail-safe fluid distribution system to obviate the aforesaid problems.

### SUMMARY OF THE INVENTION

In one aspect, the invention provides a fail-safe fluid distribution apparatus comprising

(i) a conduit through which fluid is distributed;

(ii) a fluid flow time-sensitive sensor cooperative with said conduit to operably detect fluid flow within said conduit over desired periods of time; and

(iii) a fluid control valve to control the flow of said fluid within said conduit cooperative with said sensor.

The apparatus preferably comprises a timer to activate and deactivate said sensor at desired selected times.

The apparatus comprises valve closure means wherein passage of fluid through said conduit when said sensor is activated effects closure of said valve.

The apparatus preferably comprises alarm means such as, for example, aural and/or visible units activatable when said valve is closed by said closure means in consequence of said activation of said sensor.

The apparatus may preferably comprise override valve deactivation means.

In a most preferred aspect, the invention provides a fail-safe water distribution apparatus comprising

(i) a conduit through which water is distributed;

(ii) a water flow time-sensitive sensor cooperative with said conduit to operably detect water flow within said conduit over desired periods of time; and

(iii) a water control valve to control the flow of said water within said conduit cooperative with said sensor.

### BRIEF DESCRIPTION OF THE DRAWINGS

In order that the invention may be better understood, a preferred embodiment will now be described, by way of example only, with reference to the accompanying drawing wherein

FIG. 1 is a diagrammatic perspective view of a fail-safe apparatus according to the invention.

### DETAILED DESCRIPTION OF PREFERRED EMBODIMENTS

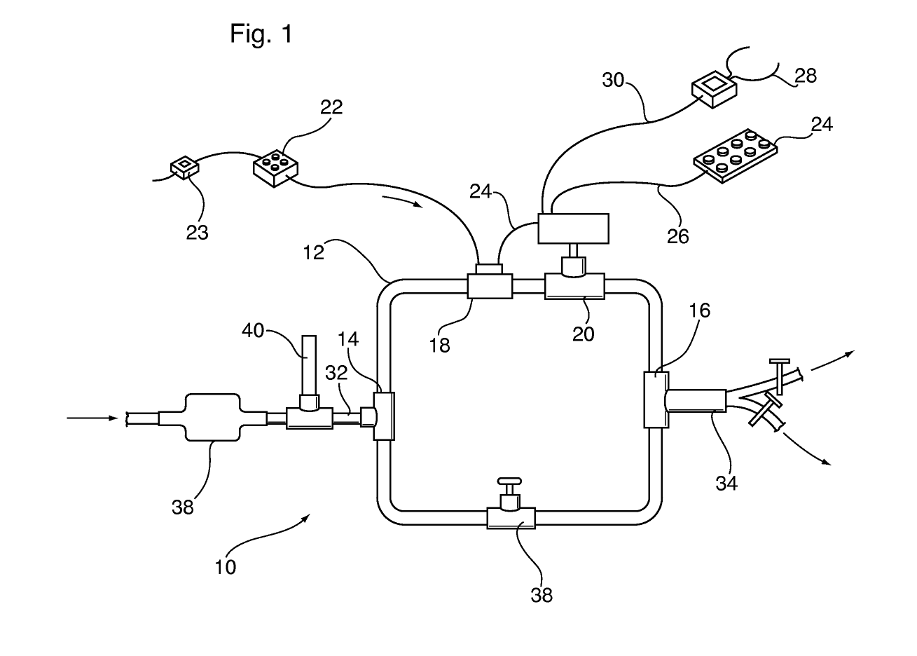

With reference to FIG. 1, this shows generally as 10 a fail-safe water distribution system having a conduit 12 with a water inlet 14 and water outlet 16 and a water flow sensor 18 and water control (electronic ball) valve 20 (Belimo Americas Danbury, Ct.) between inlet 14 and outlet 16.

Sensor 18 is activatable by water flow within conduit 12 under the control of timer 22 and power source 23 at and for selected periods of time as set and desired by an operator.

Sensor 18 is in communication with valve 20 by electrical lead 24 whereby when sensor 18 is activated by water flow during the selected period, it causes valve 20 to shut off water flow through conduit 12. Simultaneously, an electrical signal is sent to an alarm pad 24 by electrical lead 26 which activates a flashing light, alarm bell or the like (not shown).

Valve 20 is also connected to a by-pass on/off switch 28 by electrical lead 30 which causes valve 20 to remain open nothwithstanding activation by sensor 18.

Apparatus 10 is preferably used as a fail-safe system located between a water supply conduit 32 and user conduit 34.

Manual water shut-off valve 36 and bypass conduits (not shown) may be suitably placed, if desired, within or external of distribution conduit 12. A water meter 38 and optional water conduit 40 to appliances (not shown) are located external of the fail-safe apparatus of the invention.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

The embodiments of the invention to which an exclusive property or privilege is claimed are defined as follows:

1. A fail-safe fluid distribution apparatus comprising
(i) a conduit through which fluid is distributed;
(ii) a fluid flow time-sensitive sensor cooperative with said conduit to operably detect fluid flow within said conduit over desired periods of time; and
(iii) a fluid control valve to control the flow of said fluid within said conduit cooperative with said sensor.

2. A fail-safe water distribution apparatus comprising
(i) a conduit through which water is distributed;
(ii) a water flow time-sensitive sensor cooperative with said conduit to operably detect water flow within said conduit over selected desired periods of time; and
(iii) a water control valve to control the flow of said water within said conduit cooperative with said sensor.

3. Apparatus as claimed in claim 1 comprising a timer to activate and deactivate said sensor at desired selected times.

4. Apparatus as claimed in claim 1 comprising valve closure means wherein passage of fluid through said conduit when said sensor is activated effects closure of said valve.

5. Apparatus as claimed in claim 4 comprising alarm means activatable when said valve is closed by said closure means in consequence of said activation of said sensor.

6. Apparatus as claimed in claim 5 wherein said alarm means is selected from aural and visible alarm units.

7. Apparatus as claimed in claim 1 comprising override valve deactivation means.
